(19) United States
(12) Patent Application Publication
(10) Pub. No.: US 2024/0202635 A1
(43) Pub. Date: Jun. 20, 2024

(54) PERFORMANCE ASSESSMENT METHOD AND PERFORMANCE ASSESSMENT SYSTEM FOR PREHOSPITAL EMERGENCY PERSONNEL

(71) Applicant: BOE Technology Group Co., Ltd., Beijing (CN)

(72) Inventors: Qingbing Liu, Beijing (CN); Wenjin Lan, Beijing (CN); Yujing Wu, Beijing (CN); Guoqiang Zhang, Beijing (CN)

(73) Assignee: BOE Technology Group Co., Ltd., Beijing (CN)

(21) Appl. No.: 17/907,024

(22) PCT Filed: Jun. 25, 2021
(86) PCT No.: PCT/CN2021/102516

§ 371 Date: Sep. 22, 2022

(51) Int. Cl. G06Q 10/0639

(52) U.S. Cl. CPC G06Q 10/06393; G06Q 10/06398

(57) ABSTRACT

The present disclosure provides a performance assessment method and a performance assessment system for prehospital emergency personnel, the performance assessment method of the prehospital emergency personnel comprises: acquiring an employee information of prehospital emergency personnel to be subjected to performance assessment, wherein the employee information comprises a post information; acquiring a performance assessment index set for the post information; acquiring a performance assessment data corresponding to the performance assessment index of the prehospital emergency personnel within a pre-set time period; determining a performance score corresponding to the performance assessment index according to the performance assessment data; obtaining a comprehensive performance score of the prehospital emergency personnel according to a performance score corresponding to each performance assessment index of the prehospital emergency personnel.

### TECHNICAL FIELD

The embodiment of the present disclosure relates to the technical field of performance assessment, more particularly to a performance assessment method and a performance assessment system for prehospital emergency personnel.

### BACKGROUND

At present, for performance assessment of prehospital emergency personnel, manual tabulation is used to regularly count the workload, answering rate and other quantitative indicators, and then the performance is determined by scoring by the direct leaders. Manual statistical assessment needs a lot of time, and the work efficiency is low, it is inevitable to cause omissions and errors.

### SUMMARY

The embodiment of the present disclosure provides a performance assessment method and a performance assessment system for prehospital emergency personnel.

In a first aspect, the embodiment of the present disclosure provides a performance assessment method of prehospital emergency personnel, comprising:
acquiring an employee information of a prehospital emergency personnel to be subjected to performance assessment, wherein the employee information comprises a post information;
acquiring a performance assessment index set for the post information;
acquiring a performance assessment data corresponding to the performance assessment index of the prehospital emergency personnel within a pre-set time period.

Optionally, determining a performance score corresponding to the performance assessment index according to the performance assessment data; and
obtaining a comprehensive performance score of the prehospital emergency personnel according to a performance score corresponding to each the performance assessment index of the prehospital emergency personnel.

Optionally, obtaining a comprehensive performance score of the prehospital emergency personnel according to a performance score corresponding to each the performance assessment index of the prehospital emergency personnel comprises:
acquiring a weight corresponding to each performance assessment index of the prehospital emergency personnel;
multiplying a performance score corresponding to each performance assessment index of the prehospital emergency personnel by a corresponding weight to obtain a weighted score; and
adding all the weighted scores of the prehospital emergency personnel to obtain the comprehensive performance score of the prehospital emergency personnel.

Optionally, the method further comprises:
displaying performance index management interface; and
managing a performance assessment index corresponding to a target post
information and/or a weight corresponding to a performance assessment index according to an operation of a user managing in the performance index management interface.

Optionally, displaying an interface for setting a performance assessment index for the target post information in the performance index management interface; and
according to the operation of the user in the performance index management interface, wherein managing the performance assessment index comprises: taking the performance assessment index of the target post information set by the user as the performance assessment index corresponding to the target post information according to the operation of the user setting the performance assessment index for the target post information in the performance index management interface.

Optionally, displaying the interface of the performance assessment index which newly adds or deletes the target post information in the performance index management interface; and
according to the operation of the user in the performance index management interface, wherein managing the performance assessment index comprises: updating the performance assessment index corresponding to the target post information according to the operation of the performance assessment index of the target post information added or deleted by the user in the performance index management interface.

Optionally, displaying an interface which sets or modifies a weight for the performance assessment index corresponding to the target post information in the performance index management interface; and
according to the operation of the user in the performance index management interface, wherein managing the weight corresponding to the performance assessment index comprises: saving the weight set or modified by the user for the performance assessment index corresponding to the target post information according to the operation of the user setting or modifying the weight of the performance assessment index corresponding to the target post information in the performance index management interface.

Optionally, determining a performance score corresponding to the performance assessment index according to the performance assessment data comprises:
determining a performance score corresponding to the performance assessment index according to the performance assessment standard and the performance assessment data corresponding to the performance assessment index, wherein the correspondences of the performance assessment data and the performance score are recorded in the performance assessment standard.

Optionally, obtaining the comprehensive performance score of the prehospital emergency personnel according to the performance score corresponding to each the performance assessment index of the prehospital emergency personnel further comprises:
outputting the comprehensive performance score of the prehospital emergency personnel.

Optionally, the prehospital emergency personnel comprises at least one of emergency dispatcher, emergency doctor, emergency driver.

Optionally, the method further comprises:
recording the performance assessment data of each post according to the operations performed by each post during the emergency.

Optionally, recording the performance assessment data of each post according to the operations performed by each post during the emergency comprises:
obtaining the operation data recorded by dispatcher end, doctor end and driver end during the emergency and summarizing the performance assessment data recorded by emergency dispatcher, emergency doctor and emergency driver by management end.

Optionally, the performance assessment index comprises at least one of the following types: attendance assessment index, service assessment index and evaluation assessment index.

Optionally, the performance assessment index of the emergency dispatcher comprises at least one of: answering number, quality of alarm receipt, answering rate, call-off hook time, answering rate within ten seconds, acceptance duration, online duration, basic emergency medical knowledge, text input speed on computer, geographic information cognition, graph recognition technique, integrity of dispatching task information, reasonableness of dispatching, commonly applied phone number, task receiving times, number of missed calls, average off hook time, average acceptance duration and number of vehicles dispatched.

Optionally, the performance assessment index of the emergency doctor comprises at least one of: number of alarm receipts, online duration, alarm receipt rate, onboard rescue equipment use, success rate of salvage at scene, critical disease treatment rate, case writing, success rate of CPR at scene, response rate within three minutes, number of assigned tasks, number of completed tasks, number of cancelled vehicle dispatch, number of tasks rejected due to timeout and number of saved patients.

Optionally, the performance assessment index of the emergency driver comprises at least one of: number of alarm receipts, response rate within three minutes, online duration, vehicle status, safe driving, driving under complex road conditions, faults judgement and removal, master of Traffic Laws and Regulations, number of assigned tasks, number of completed tasks, number of cancelled vehicle dispatch, number of tasks rejected due to timeout, time used for vehicle dispatch and mileage of vehicle dispatch.

In a second aspect, the embodiment of the present disclosure provides a performance assessment system of prehospital emergency personnel, comprising:
a first acquisition module for acquiring an employee information of a prehospital emergency personnel to be subjected to performance assessment, wherein the employee information comprises a post information;
a second acquisition module for acquiring a performance assessment index set for the post information;
a third acquisition module for acquiring a performance assessment data corresponding to the performance assessment index of the prehospital emergency personnel within a pre-set time period;
a first determination module for determining a performance score corresponding to the performance assessment index according to the performance assessment data; and
a second determination module for obtaining a comprehensive performance score of the prehospital emergency personnel according to a performance score corresponding to each the performance assessment index of the prehospital emergency personnel.

In a third aspect, the embodiment of the present disclosure provides an electronic device, comprising: a processor, a memory and a program stored on the memory and executable on the processor, the program implementing the steps of the performance assessment method of the prehospital emergency personnel when executed by the processor.

In a fourth aspect, the embodiment of the present disclosure provides a computer readable storage medium, wherein a computer program is stored on the computer readable storage medium, the program implementing the steps of the performance assessment method of the prehospital emergency personnel when executed by the processor.

### BRIEF DESCRIPTION OF THE DRAWINGS

Numerous additional advantages and benefits will become apparent to those of ordinary skill in the art upon reading the following detailed description of the preferred embodiment. The drawings are only for purposes of illustrating the preferred embodiment and are not to be construed as limiting the disclosure. Furthermore, the same reference symbols are used to denote the same parts throughout the drawings. In the drawings:

FIG. 1 is a flow diagram of performance assessment method of prehospital emergency personnel according to an embodiment of the present disclosure;

FIG. 2 is a schematic diagram of performance assessment index of prehospital emergency personnel according to the embodiment of the present disclosure;

FIG. 3 is a schematic view of the Smart Emergency system according to the embodiment of the present disclosure;

FIG. 4 is a flow diagram of performance assessment method of prehospital emergency personnel according to another embodiment of the present disclosure;

FIG. 5 is a flow diagram of performance assessment method of prehospital emergency personnel according to yet another embodiment of the present disclosure;

FIG. 6 is a flow diagram of performance assessment method of prehospital emergency personnel according to yet another embodiment of the present disclosure;

FIG. 7 is a schematic view of performance assessment system of prehospital emergency personnel according to the embodiment of the present disclosure;

FIG. 8 is a schematic view of electronic device according to the embodiment of the present disclosure.

### DETAILED DESCRIPTION

The technical solution in the embodiment of the present disclosure will be clearly and completely described below in connection with the accompanying drawings in the embodiment of the present disclosure, and it is apparent that the described embodiment is a part of the embodiment of the present disclosure rather than the whole embodiment. Based on the embodiment in the present disclosure, all other embodiments obtained by a person of ordinary skill in the art without involving any inventive effort fall within the range of the present disclosure. The prehospital emergency system may include an alarm end, a dispatch center end, a doctor end, a driver end and a management end. User gives an alarm via an alarm end, and an emergency dispatcher of the dispatching center receives the alarm telephone via the dispatching center and allocates an ambulance vehicle and ambulance resource, etc.; at the same time, the dispatcher of the dispatching center can also allocate an emergency driver and a doctor (emergency doctor). The driver is an employee assigned to drive the ambulance vehicle to the alert location, and the doctor is an employee assigned to travel with the ambulance to the alert location. The driver uses a driver end for navigation, and doctor can use a doctor end to enter EMR information and treatment information to the personnel to be treated on the ambulance, etc.

The alarm end, the dispatch center end, the doctor end, the driver end and the management end can be electronic devices, such as mobile phone, tablet, computer, all-in-one machine, etc.

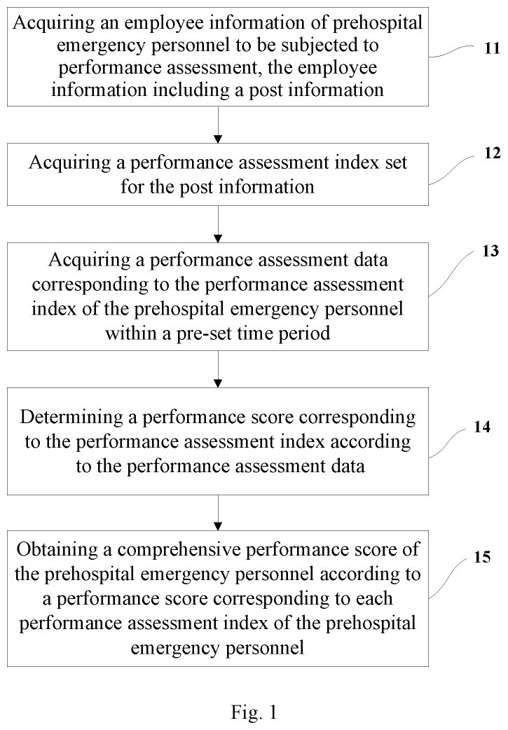

With reference to FIG. 1, the embodiment of the present disclosure provides a performance assessment method for prehospital emergency personnel, the main body of the execution of the method can be any electronic devices, for example, it can be applied to an application program with performance assessment function, the method can be executed by a server of the application program or a terminal equipment, and optionally, the method can be executed by a management end, comprising:

Step 11: acquiring an employee information of a prehospital emergency personnel to be subjected to performance assessment, wherein the employee information comprises a post information;

In some embodiments, the prehospital emergency personnel to be subjected to performance assessment include: at least one of emergency dispatcher, emergency doctor and emergency driver.

For example, the post information may be an emergency doctor, an emergency nurse, an emergency driver, an emergency dispatcher and an emergency manager, etc.

Step 12: acquiring a performance assessment index set for the post information;

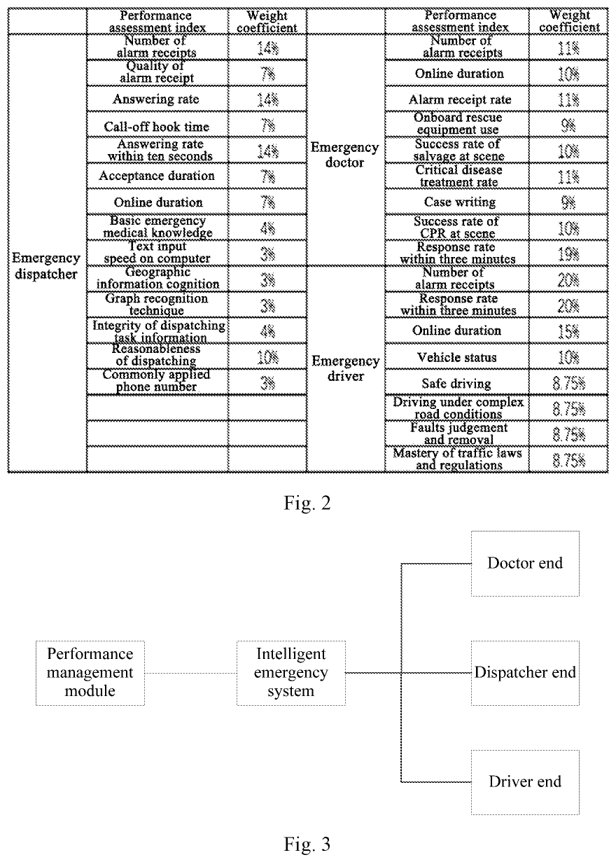

In the embodiment of the present disclosure, optionally, each post corresponds to a group of performance assessment indexes, and referring to FIG. 2, the performance assessment index of emergency dispatcher comprises: at least one of answering number, quality of alarm receipt, answering rate, call-off hook time, answering rate within ten seconds, acceptance duration, online duration, basic emergency medical knowledge, text input speed on computer, geographic information cognition, graph recognition technique, integrity of dispatching task information, reasonableness of dispatching, commonly applied phone number, task receiving times, number of missed calls, average off hook time, average acceptance duration and number of vehicles dispatched. The emergency doctor's performance assessment index includes: at least one of number of alarm receipts, online duration, alarm receipt rate, onboard rescue equipment use, success rate of salvage at scene, critical disease treatment rate, case writing, success rate of CPR at scene, response rate within three minutes, number of assigned tasks, number of completed tasks, number of cancelled vehicle dispatch, number of tasks rejected due to timeout and number of saved patients. The performance assessment index of the emergency driver comprises: at least one of number of alarm receipts, response rate within three minutes, online duration, vehicle status, safe driving, driving under complex road conditions, faults judgement and removal, master of Traffic Laws and Regulations, number of assigned tasks, number of completed tasks, number of cancelled vehicle dispatch, number of tasks rejected due to timeout, time used for vehicle dispatch and mileage of vehicle dispatch.

Each performance assessment index of emergency dispatcher is described below.
answering number refers to the number of emergency alert calls received by emergency dispatcher;
quality of alarm receipt refers to the quality of dispatching after emergency dispatcher receives emergency alert calls;
answering rate refers to the ratio of the number of emergency alert calls connected by emergency dispatcher to the number of emergency alert calls;
call-off hook time refers to the delay time of emergency dispatcher off-hook after the emergency alert calls;
answering rate within ten seconds refers to the ratio of the number of calls picked up by emergency dispatcher within ten seconds after the emergency alert calls to the total number of emergency alert calls picked up by the emergency dispatcher;
acceptance duration refers to duration that emergency dispatcher accepts emergency alert calls, including answering duration and dispatching duration;
online duration refers to duration where emergency dispatcher is in working post;
basic emergency medical knowledge refers to the mastery of basic emergency medical knowledge by emergency dispatcher;
text input speed on computer refers to text input speed on computer when emergency dispatcher receives an alarm;
geographic information cognition refers to the mastery of region's geographical position by emergency dispatcher;
graph recognition technique refers to the mastery of electronic maps by emergency dispatcher;
integrity of dispatching task information refers to the completeness of the completion of dispatching task information when emergency dispatcher dispatches tasks;
reasonableness of dispatching refers to whether emergency dispatcher dispatches doctor and driver reasonably;

Each performance assessment index of emergency doctor is described below.
number of alarm receipts refers to the number of emergency alert events handled by emergency doctor;
online duration refers to duration where emergency doctor is in working post;
alarm receipt rate refers to the ratio of the number of alarm receipts of emergency doctor to the number of alarm receipts of all emergency doctors;
onboard rescue equipment usage refers to the usage of onboard rescue equipment by emergency doctor;
success rate of salvage at scene refers to the ratio of successfully rescuing patient by emergency doctor in all the alarming events by this doctor;
critical disease treatment rate refers to the ratio of the number of critically ill patient salvaged by emergency doctor to the number of all patients salvaged by this doctor;
case writing refers to the case where emergency doctor writes the EMR book.
success rate of CPR at scene refers the ratio of the number of successful CPR performed on-site on patient by emergency doctor to the total number of CPR performed by this doctor;
response rate within three minutes refers the ratio of the number of alarms in three minutes after the emergency doctor is assigned to alarms to the total number of alarms for this emergency doctor.

Each performance assessment index of emergency driver is described below.
number of alarm receipts refers to the number of emergency alert events handled by emergency driver;
response rate within three minutes refers to the ratio of the number of departures in three minutes after the emergency driver is assigned to the total number of departures of this emergency driver;
online duration refers to duration where emergency driver is in working post;
vehicle status refers to the state of the vehicle of emergency driver, such as whether it is tidy, whether the equipment is complete, etc.
safe driving refers to whether there are violations and accidents of emergency driver in the process of departure;
driving under complex road conditions refers to the processing capability of emergency driver under complex path;
faults judgement and removal refers to the ability of emergency driver to judge and troubleshoot;
the mastery of traffic laws and regulations refers to the mastery of traffic laws and regulations by emergency driver.

Step 13: acquiring a performance assessment data corresponding to the performance assessment index of the prehospital emergency personnel within a pre-set time period.

In the embodiment of the present disclosure, the pre-set time period may be set as needed, for example, one month, one quarter, etc.

The performance assessment data corresponding to the performance assessment index can be the data recorded in real time during an alarm receiving process. For example, recording the performance assessment data of each post according to the operations performed by each post during the emergency.

In some embodiments of the present disclosure, the performance assessment data of each post may be recorded by an intelligent emergency system, for example, by management end. Data related to operations such as receiving an alarm and assigning a task performed by the intelligent emergency system can all be recorded in the system, and when using the intelligent emergency system, each post can respectively have its own operation end, such as emergency dispatcher, emergency doctor and emergency driver can respectively use intelligent emergency system-dispatcher end, intelligent emergency system-doctor end and intelligent emergency system-driver end, wherein each post performs relevant task operations on its respective operation end (including emergency dispatcher answering alarm calls, assigning tasks, etc. emergency doctor traveling with ambulance, etc. related operations), all can record operation-related data (e. g. dispatcher end call-off hook time is 3 seconds) in intelligent emergency system, referring to FIG. 3. Real-time recording of data can ensure the authenticity and integrity of data. For example, the operation of each post on each end can be summarized and recorded by the management end.

That is, based on the operations performed by each post during emergency, recording the performance assessment data for each post includes: obtaining the operation data recorded by dispatcher end, doctor end and driver end during the emergency and summarizing the performance assessment data recorded by emergency dispatcher, emergency doctor and emergency driver by management end.

Step 14: determining a performance score corresponding to the performance assessment index according to the performance assessment data; and
in the embodiment of the present disclosure, the performance score corresponding to the performance assessment index can be determined according to the performance assessment standard corresponding to the performance assessment index and the performance assessment data, wherein the correspondences of the performance assessment data and the performance score are recorded in the performance assessment standard. For example, the call-off hook time of dispatcher end has a performance assessment standard of 5 seconds, 10 points if the off hook time is less than 5 seconds, 5 points if the off hook time is greater than 5 seconds and less than 8 seconds, and 2 points if the off hook time is greater than 8 seconds.

The performance assessment standard corresponding to the above-mentioned performance assessment index can be pre-set or changed according to specific needs, so as to ensure the objectivity of scoring compared with manual scoring.

Step 15: obtaining a comprehensive performance score of the prehospital emergency personnel according to a performance score corresponding to each the performance assessment index of the prehospital emergency personnel.

In the embodiment of the present disclosure, the performance assessment of the prehospital emergency personnel is completed by an automated means to improve the working efficiency, and the problem of omission and error can be effectively avoided. Furthermore, we should further deepen the reform of medical and health system, mobilize the enthusiasm of staff in prehospital emergency institutions, enhance service awareness, improve work style, improve service level and improve the quality of prehospital emergency.

In some embodiments of the present disclosure, optionally, the performance score corresponding to each the performance assessment index of the prehospital emergency personnel may be directly added to obtain the comprehensive performance score of the prehospital emergency personnel.

However, for the same post, different performance assessment indexes also have different importance, and accordingly, in other embodiments of the present disclosure, optionally, according to the performance score corresponding to each performance assessment index of the prehospital emergency personnel, obtaining the comprehensive performance score of the prehospital emergency personnel comprises:
Step 151: acquiring a weight corresponding to each performance assessment index of the prehospital emergency personnel;
Step 152: multiplying a performance score corresponding to each performance assessment index of the prehospital emergency personnel by a corresponding weight to obtain a weighted score; and
Step 153: adding all the weighted scores of the prehospital emergency personnel to obtain the comprehensive performance score of the prehospital emergency personnel.

Namely, the weighted score of each the performance assessment index of the prehospital emergency personnel=the performance score of the performance assessment index*the weight of the performance score corresponding to the performance assessment index; and
the comprehensive performance score for prehospital emergency personnel=Σ(the weighted score for each performance assessment index).

For example, referring to FIG. 2, the emergency dispatcher comprises 14 performance assessment indexes, and according to the importance of each performance assessment index, each performance assessment index is allocated a corresponding weight, for example, the number of alarm receipts, the answering rate and the answering rate within ten seconds are the three most important performance assessment indexes, and then 14% of weight is respectively allocated to the three performance assessment indexes, followed by the allocation rationality, and 10% of weight is allocated to it. When calculating the comprehensive performance score of an emergency dispatcher, the performance score corresponding to each performance assessment index of the emergency dispatcher can be multiplied by the weight corresponding to the performance assessment index to obtain the weighted score and add the weighted score corresponding to all performance assessment indexes, to obtain the comprehensive performance score of the emergency dispatcher.

Optionally, the method of the embodiment of the present invention further comprises:
displaying performance index management interface; and
managing a performance assessment index corresponding to a target post information and/or a weight corresponding to a performance assessment index according to an operation of a user managing in the performance index management interface.

In the embodiment of the present disclosure, the performance assessment index of each post and/or the weight corresponding to the performance assessment index can be conveniently managed through a human-computer interaction interface, thus improving the user experience.

In the embodiment of the present disclosure, a performance assessment index library can be pre-set based on the National Department of Health guidance on prehospital emergency and performance assessment index, wherein the performance assessment index library can record quantified performance assessment index, including but not limited to performance assessment index of post such as emergency doctor, nurse, emergency driver, emergency dispatcher, managers, etc. The performance assessment index comprises at least one of the following types: attendance assessment index, service assessment index (such as work efficiency, quality of work, professional skills, etc.) and evaluation assessment index (including participation in the rescue of major events or major activity guarantee, and commendation and reward of the government, etc.).

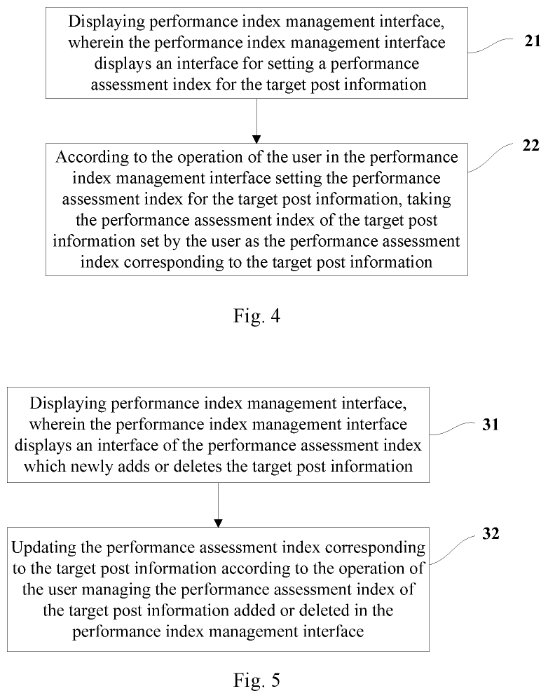

In some cases, for some facilities, it may not be necessary to have all performance assessment indexes in the performance assessment index library corresponding to employee post. Thus, referring to FIG. 4, the performance assessment method of embodiment of the present disclosure may further comprise:

Step 21: displaying an interface for setting a performance assessment index for the target post information in the performance index management interface; and

Step 22: according to the operation of the user in the performance index management interface setting the performance assessment index for the target post information, taking the performance assessment index of the target post information set by the user as the performance assessment index corresponding to the target post information.

For example, each working post is displayed in the performance index management interface, and when user clicks a certain post, all the performance assessment indexes corresponding to the post can be obtained from the performance assessment index library, so that all the performance assessment indexes corresponding to the post can be selected, and the required performance assessment index can be selected.

In the embodiment of the present disclosure, the performance assessment index can be conveniently set for each post through a human-computer interaction interface, thus improving the user experience.

In some embodiments of the present disclosure, optionally, referring to FIG. 5, the performance assessment method of embodiment of the present disclosure may further comprise:
Step 31: displaying an interface for setting a performance assessment index for the target post information in the performance index management interface; and
Step 32: updating the performance assessment index corresponding to the target post information according to the operation of the user managing the performance assessment index of the target post information added or deleted by the interface in the performance index.

That is, the user can easily update the performance assessment index of each post information through human-computer interaction interface to further improve the user experience.

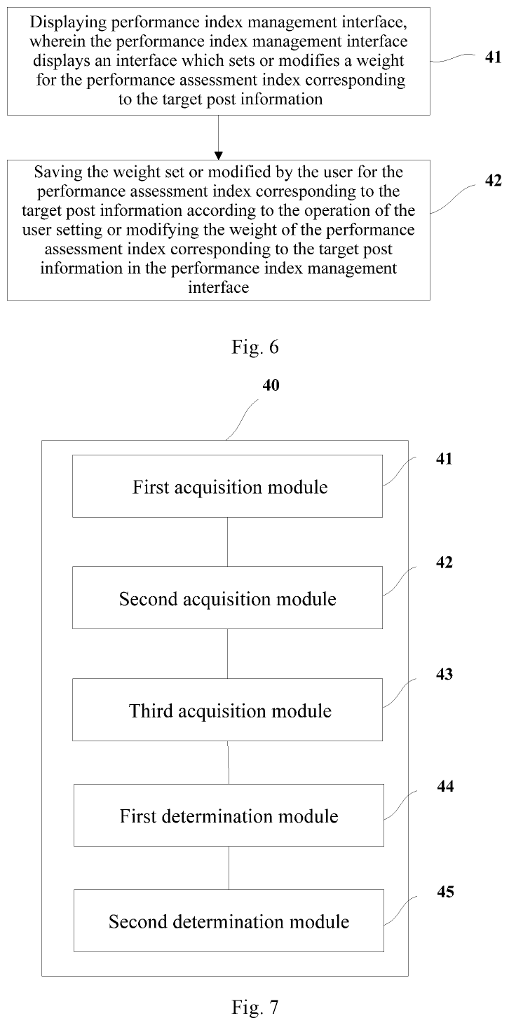

In some embodiments of the present disclosure, optionally, referring to FIG. 6, the performance assessment method of embodiment of the present disclosure may further comprise:
Step 41: displaying an interface which sets or modifies a weight for the performance assessment index corresponding to the target post information in the performance index management interface;
Step 42: saving the weight set or modified by the user for the performance assessment index corresponding to the target post information according to the operation of the user setting or modifying the weight of the performance assessment index corresponding to the target post information in the performance index management interface

That is, the user can easily set or modify the weight of performance assessment index of each post information through human-computer interaction interface to further improve the user experience.

In the embodiment of the present disclosure, optionally, obtaining the comprehensive performance score of the prehospital emergency personnel according to the performance score corresponding to each the performance assessment index of the prehospital emergency personnel further comprises: outputting the comprehensive performance score of the prehospital emergency personnel for user to review.

It should be noted that although the steps of the methods of the present disclosure are depicted in the drawings in a particular order, this does not require or imply that the steps be performed in the particular order, or that all illustrated steps be performed, to achieve the desired results. Additionally, or alternatively, certain steps may be omitted, multiple steps combined into one step execution, and/or one step decomposed into multiple step executions, etc.

Referring to FIG. 7, the embodiment of the present disclosure also provides a performance assessment system 40 of prehospital emergency personnel, comprising:
a first acquisition module for acquiring an employee information of a prehospital emergency personnel to be subjected to performance assessment, wherein the employee information comprises a post information;
a second acquisition module for acquiring a performance assessment index set for the post information;
a third acquisition module for acquiring a performance assessment data corresponding to the performance assessment index of the prehospital emergency personnel within a pre-set time period;
a first determination module for determining a performance score corresponding to the performance assessment index according to the performance assessment data; and
a second determination module for obtaining a comprehensive performance score of the prehospital emergency personnel according to a performance score corresponding to each the performance assessment index of the prehospital emergency personnel.

In the embodiment of the present disclosure, the performance assessment of the prehospital emergency personnel is completed by an automated means to improve the working efficiency, and the problem of omission and error can be effectively avoided. Furthermore, we should further deepen the reform of medical and health system, mobilize the enthusiasm of staff in prehospital emergency institutions, enhance service awareness, improve work style, improve service level and improve the quality of prehospital emergency.

In the embodiment of the present disclosure, optionally, the second determination module 45 comprises:
a first acquisition sub-module for acquiring a weight corresponding to each performance assessment index of the prehospital emergency personnel;
a first calculation sub-module for multiplying a performance score corresponding to each performance assessment index of the prehospital emergency personnel by a corresponding weight to obtain a weighted score; and
a second calculation sub-module for adding all the weighted scores of the prehospital emergency personnel to obtain the comprehensive performance score of the prehospital emergency personnel.

Optionally, the performance assessment system 40 of prehospital emergency personnel according to the embodiment of the present disclosure further comprises:
a display module, for displaying the performance index management interface; and
a management module, for managing the performance assessment index corresponding to the target post information and/or the weight corresponding to the performance assessment index according to the operation of the user in the performance index management interface.

Optionally, displaying an interface for setting a performance assessment index for the target post information in the performance index management interface; and
the management module is used for setting the performance assessment index of the target post information set by the user as the performance assessment index corresponding to the target post information according to the operation of the user setting the performance assessment index for the target post information in the performance index management interface.

Optionally, displaying the interface of the performance assessment index which newly adds or deletes the target post information in the performance index management interface; and
the management module is used for updating the performance assessment index corresponding to the target post information according to the operation of the user managing the performance assessment index of the target post information added or deleted by the interface in the performance index. Optionally, displaying an interface which sets or modifies a weight for the performance assessment index corresponding to the target post information in the performance index management interface; and
the management module is used for saving the weight set or modified by the user for the performance assessment index corresponding to the target post information according to the operation of the user setting or modifying the weight of the performance assessment index corresponding to the target post information at the performance index management interface.

In the embodiment of the present disclosure, optionally, the second determination module 45 is specifically used for determining the performance score corresponding to the performance assessment index according to the performance assessment standard corresponding to the performance assessment index and the performance assessment data, wherein the correspondence of the performance assessment data and the performance score is recorded in the performance assessment standard.

In the embodiment of the present disclosure, optionally, the performance assessment system 40 of prehospital emergency personnel of the embodiment of the present disclosure further comprises:
an outputting module, for outputting the comprehensive performance score of the prehospital emergency personnel.

Optionally, the prehospital emergency personnel comprises at least one of emergency dispatcher, emergency doctor, emergency driver.

Optionally, the performance assessment system 40 of prehospital emergency personnel according to the embodiment of the present disclosure further comprises:
a recording module, for recording the performance assessment data of each post according to the operations performed by each post during the emergency.

Optionally, the recording module is used to obtain the operation data recorded by dispatcher end, doctor end and driver end during the emergency, and summarize the performance assessment data recorded by emergency dispatcher, emergency doctor and emergency driver.

Optionally, the performance assessment index comprises at least one of the following types: attendance assessment index, service assessment index and evaluation assessment index.

Optionally, the performance assessment index of the emergency dispatcher comprises at least one of: answering number, quality of alarm receipt, answering rate, off hook time, answering rate within ten seconds, acceptance duration, online duration, basic emergency medical knowledge, text input speed on computer, geographic information cognition, graph recognition technique, integrity of dispatching task information, reasonableness of dispatching, commonly applied phone number.

Optionally, the performance assessment index of the emergency doctor comprises at least one of: number of alarm receipts, online duration, alarm receipt rate, onboard rescue equipment, success rate of salvage at scene, critical disease treatment rate, case writing, success rate of CPR at scene, response rate within three minutes.

Optionally, the performance assessment index of the emergency driver comprises at least one of: number of alarm receipts, response rate within three minutes, online duration, vehicle status, safe driving, driving under complex road conditions, faults judgement and removal, the mastery of traffic laws and regulations.

Each module in the above-mentioned apparatus may be a general-purpose processor, comprising: a Central Processing Unit, a network processor, etc.; it can also be a digital signal processor, an Application Specific Integrated Circuits, a Field Programmable Gate Array or other programmable logic devices, a discrete gate or a transistor logic device, a discrete hardware component. Each module may also be implemented in software, firmware, etc. Each processor in the above-mentioned apparatus may be a separate processor or may be integrated together.

It should be noted that while several modules or cells of equipment for action execution are mentioned in the above detailed description, such partitioning is not mandatory. Indeed, the features and functions of two or more modules or cells described above may be embodied in one module or cell according to the embodiment of the present disclosure. Conversely, the features and functions of one module or cell described above can be further divided into being embodied by multiple modules or cells.

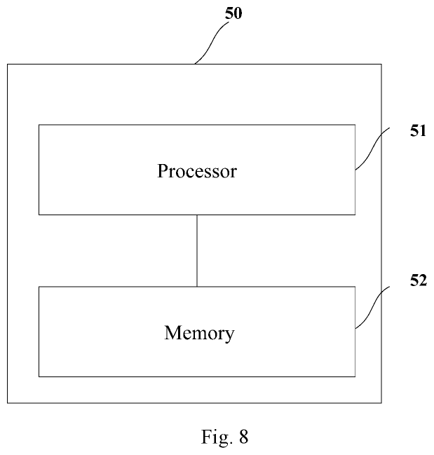

Referring to FIG. 8, the embodiment of the present invention also provides an electronic device 50, comprising a processor 51, a memory 52, and a computer program which is stored on the memory 52 and can be run on the processor 51, and when the computer program is executed by the processor 51, various processes of the above-mentioned performance assessment method embodiment of the prehospital emergency personnel are implemented, and the same technical effect can be achieved, and in order to avoid repetition, the description thereof will not be repeated.

The embodiment of the present invention also provides a computer readable storage medium, wherein a computer program is stored on the computer readable storage medium, and when the computer program is executed by the processor, various processes of the above-mentioned performance assessment method embodiment of the prehospital emergency personnel are implemented, and the same technical effects can be achieved, and in order to avoid repetition, the description thereof will not be repeated. Wherein the computer readable storage medium, such as read-only memory (ROM), random-access memory (RAM), magnetic disk or optical disk, etc.

It should be noted that, as used herein, the terms “comprises”, “comprising”, or any other variation thereof, are intended to cover a non-exclusive inclusion, such that a process, a method, an article, or an apparatus that comprises a list of elements does not include only those elements but may include other elements not expressly listed or inherent to such process, method, article, or apparatus. An element defined by “comprises a . . . ” does not, without more constraints, preclude the existence of additional identical elements in the process, method, article, or apparatus that comprises the element.

From the above description of embodiment, it is clear to a person skilled in the art that the above embodiment method can be implemented by means of software plus the necessary general hardware platform, but of course also by means of hardware. Based on this understanding, the technical solution of the present invention, in essence or the part that contributes to the prior art, can be embodied in the form of software product which is stored in a storage medium (such as ROM/RAM, magnetic disk, optical disk) and includes a plurality of instructions to enable a terminal (which may be a cell phone, a computer, a server, an air conditioner, or a network equipment, etc.) to execute the methods described in each embodiment of the present invention.

Although the embodiment of the present disclosure has been described above with reference to the accompanying drawings, the present disclosure is not limited to the specific embodiments described above. The specific embodiments described above are merely illustrative and not restrictive, and those skilled in the art, in light of the present disclosure, can make many changes without departing from the range as claimed in the spirit and claims of the present disclosure.

1. A performance assessment method of prehospital emergency personnel, comprising:
acquiring an employee information of prehospital emergency personnel to be subjected to performance assessment, wherein the employee information comprises a post information;
acquiring a performance assessment index set for the post information;
acquiring a performance assessment data corresponding to the performance assessment index of the prehospital emergency personnel within a pre-set time period; and
displaying the performance assessment data by performance index management interface.

2. The method according to claim 1, further comprising:
determining a performance score corresponding to the performance assessment index according to the performance assessment data; and
obtaining a comprehensive performance score of the prehospital emergency personnel according to a performance score corresponding to each performance assessment index of the prehospital emergency personnel.

3. The method according to claim 2, wherein the obtaining the comprehensive performance score of the prehospital emergency personnel according to the performance score corresponding to each performance assessment index of the prehospital emergency personnel comprises:
acquiring a weight corresponding to each performance assessment index of the prehospital emergency personnel;
multiplying a performance score corresponding to each performance assessment index of the prehospital emergency personnel by a corresponding weight to obtain a weighted score; and
adding all the weighted scores of the prehospital emergency personnel to obtain the comprehensive performance score of the prehospital emergency personnel.

4. The method according to claim 1, further comprising:
displaying performance index management interface; and
managing a performance assessment index corresponding to a target post information and/or a weight corresponding to a performance assessment index according to an operation of a user managing in the performance index management interface.

5. The method according to claim 4, wherein
the performance index management interface displays an interface for setting a performance assessment index for the target post information; and
according to the operation of the user in the performance index management interface, the managing the performance assessment index comprises: taking the performance assessment index of the target post information set by the user as the performance assessment index corresponding to the target post information according to the operation of the user setting the performance assessment index for the target post information in the performance index management interface.

6. The method according to claim 4, wherein
the performance index management interface displays an interface of the performance assessment index which newly adds or deletes the target post information; and
according to the operation of the user in the performance index management interface, the managing the performance assessment index comprises: updating the performance assessment index corresponding to the target post information according to the operation of the performance assessment index of the target post information added or deleted by the user in the performance index management interface.

7. The method according to claim 4, wherein
the performance index management interface displays an interface which sets or modifies a weight for the performance assessment index corresponding to the target post information; and
according to the operation of the user in the performance index management interface, the managing the weight corresponding to the performance assessment index comprises: saving the weight set or modified by the user for the performance assessment index corresponding to the target post information according to the operation of the user setting or modifying the weight of the performance assessment index corresponding to the target post information in the performance index management interface.

8. The method according to claim 2, wherein the determining the performance score corresponding to the performance assessment index according to the performance assessment data comprises:
determining a performance score corresponding to the performance assessment index according to performance assessment standard and the performance assessment data corresponding to the performance assessment index, wherein correspondences of the performance assessment data and the performance score are recorded in the performance assessment standard.

9. The method according to claim 2, wherein after obtaining the comprehensive performance score of the prehospital emergency personnel according to the performance score corresponding to each performance assessment index of the prehospital emergency personnel, the method further comprises:
outputting the comprehensive performance score of the prehospital emergency personnel.

10. The method according to claim 1, wherein the prehospital emergency personnel comprise at least one of emergency dispatcher, emergency doctor, and emergency driver.

11. The method according to claim 1, further comprising:
recording the performance assessment data of each post according to operations performed by each post during an emergency.

12. The method according to claim 11, wherein the recording the performance assessment data of each post according to the operations performed by each post during the emergency comprises:
acquiring operation data recorded by dispatcher end, doctor end and driver end during the emergency and summarizing the performance assessment data recorded by emergency dispatcher, emergency doctor and emergency driver by management end.

13. The method according to claim 1, wherein the performance assessment index comprises at least one of the following types: attendance assessment index, service assessment index and evaluation assessment index.

14. The method according to claim 12, wherein
the performance assessment index of the emergency dispatcher comprises at least one of: answering number, quality of alarm receipt, answering rate, call-off hook time, answering rate within ten seconds, acceptance duration, online duration, basic emergency medical knowledge, text input speed on computer, geographic information cognition, graph recognition technique, integrity of dispatching task information, reasonableness of dispatching, commonly applied phone number, task receiving times, number of missed calls, average off hook time, average acceptance duration and number of vehicles dispatched.

15. The method according to claim 12, wherein
the performance assessment index of the emergency doctor comprises at least one of: number of alarm receipts, online duration, alarm receipt rate, onboard rescue equipment use, success rate of salvage at scene, critical disease treatment rate, case writing, success rate of CPR at scene, response rate within three minutes, number of assigned tasks, number of completed tasks, number of cancelled vehicle dispatch, number of tasks rejected due to timeout and number of saved patients.

16. The method according to claim 12, wherein
the performance assessment index of the emergency driver comprises at least one of: number of alarm receipts, response rate within three minutes, online duration, vehicle status, safe driving, driving under complex road conditions, faults judgement and removal, master of Traffic Laws and Regulations, number of assigned tasks, number of completed tasks, number of cancelled vehicle dispatch, number of tasks rejected due to timeout, time used for vehicle dispatch and mileage of vehicle dispatch.

17. A performance assessment system of prehospital emergency personnel, comprising:
a first acquisition module for acquiring an employee information of prehospital emergency personnel to be subjected to performance assessment, wherein the employee information comprises a post information;
a second acquisition module for acquiring a performance assessment index set for the post information;
a third acquisition module for acquiring a performance assessment data corresponding to the performance assessment index of the prehospital emergency personnel within a pre-set time period;
a first determination module for determining a performance score corresponding to the performance assessment index according to the performance assessment data; and
a second determination module for obtaining a comprehensive performance score of the prehospital emergency personnel according to a performance score corresponding to each performance assessment index of the prehospital emergency personnel.

18. A electronic device, comprising: a processor, a memory and a program stored on the memory and executable on the processor, the program implementing the steps of the performance assessment method of prehospital emergency personnel according to claim 1 when executed by the processor.

19. A computer readable storage medium, wherein a computer program is stored on the computer readable storage medium, the computer program implementing the steps of the performance assessment method of prehospital emergency personnel according to claim 1 when executed by a processor.
